(19) United States
(12) Patent Application Publication
(10) Pub. No.: US 2014/0006780 A1
(43) Pub. Date: Jan. 2, 2014

(54) TRANSACTION VERIFICATION

(71) Applicant: NetAuthority, Inc., Fremont, CA (US)

(72) Inventors: Talbot HARTY, Sutter Creek, CA (US); Dono HARJANTO, Irvine, CA (US); Karim KADDOURA, San Francisco, CA (US); Prakash CHANDRA, Fremont, CA (US)

(21) Appl. No.: 13/919,883

(22) Filed: Jun. 17, 2013

Related U.S. Application Data
(60) Provisional application No. 61/664,856, filed on Jun. 27, 2012.

(30) Foreign Application Priority Data
Oct. 18, 2012 (AU) 2012101560

(51) Int. Cl. H04L 29/06

(52) U.S. Cl. CPC H04L 63/0428
USPC 713/168

(57) ABSTRACT

A client computer returns to a server, not only form data entered by the user representing an action to be taken by the server, but also a hash of the form data that is generated by a cryptographic hash function prior to returning the form data. As a result, the hash is generated before any man-in-the-browser proxy has the opportunity to modify the form data. The server receives the hash of the form data generated before any man-in-the-browser proxy had access to the form data. If a hash of the form data does not match the received hash, the server detects modification of the form data, perhaps by a man-in-the-browser proxy, and accordingly declines to perform the requested action.

This application claims priority to U.S. Provisional Application No. 61/664,856, which was filed Jun. 27, 2012, and which is fully incorporated herein by reference.

### BACKGROUND OF THE INVENTION

1. Field of the Invention

The present invention relates generally to network-based computer security and, more particularly, methods of and systems for verifying that network transactions have not been altered, e.g., by a man-in-the-browser attack.

2. Description of the Related Art

Web-based banking and financial transactions today have become preferred by many relative to in-branch or even ATM (automatic teller machine) transactions. Accordingly, security of such web-based transactions has tremendous importance.

One attack to which such web-based transactions are vulnerable is the man-in-the-browser attack. This attack begins with installation of malicious software in a victim computer, commonly by a Trojan horse attack, i.e., fooling a user of the victim computer into unwittingly executing software that installs the malicious software.

The malicious software is installed as a proxy, meaning that the web browser of the victim computer sends and receives all network traffic through the malicious software, which in turn forwards the data to and from a computer network on behalf of the web browser. Mostly, the malicious software forwards data in both directions faithfully, so the user of the victim computer does not observe any unusual behavior by the web browser.

However, the malicious software is typically configured to detect financial transactions. When the user of the victim computer enters data specifying a financial transaction, the malicious software can modify the destination account information and the amount to be transferred so as to re-direct money to an account other than the one intended by the user of the victim computer. The malicious software can then send the modified transaction attributes to the server of the financial institution to effect the unauthorized transaction.

Upon completion of the transaction, the server of the financial institution provides confirmation of the successful completion or scheduling of the transaction. Since the malicious software is a proxy, the malicious software intercepts the confirmation and substitutes the modified data with the data that was originally entered by the user. As a result, the user sees a transaction confirmation that indicates that the transaction was completed or acknowledged as entered by the user. However, this transaction confirmation has been falsified by the malicious software.

The conventional approach to security for web-based transactions includes Secure Sockets Layer (SSL) and Transport Layer Security (TLS). These protocols work at the application layer to encrypt data transported between the client and the server. However, since the encryption is performed at the application layer, the operating system of the victim computer performs the encryption of data sent and the decryption of data received. Among software installed in the victim computer, including the web browser and the malicious software, data is exchanged in clear text, i.e., not encrypted. Accordingly, SSL/TSL does not prevent man-in-the-browser attacks.

Anti-virus and anti-spyware techniques can be used to detect and remove malicious software, but usually only after substantial damage has been done by such malicious software. In addition, people perpetuating man-in-the-browser attacks frequently modify the malicious software to avoid detection. Anti-virus and anti-spyware techniques are therefore inadequate.

What is needed is a way to stop all man-in-the-browser attacks without requiring detection and removal of any malicious software.

### SUMMARY OF THE INVENTION

In accordance with the present invention, a client computer returns to a server, not only form data entered by the user representing an action to be taken by the server, but also a hash of the form data that is generated by a cryptographic hash function prior to returning the form data. As a result, the hash is generated before any man-in-the-browser proxy has the opportunity to modify the form data.

As used herein, a cryptographic hash function is data processing logic that processes a source body of data to form resulting hash data in such a way that applying the same cryptographic hash function to the source data with any modification will result in different hash data. In general, a good cryptographic hash function will have the following properties: (i) derivation of the source data from the hash data is intractable, (ii) modification of the source data such that the resulting hash data does not change is intractable, and (iii) finding two different bodies of source data that result in identical hash data is intractable.

When the server receives the form data entered by the user to specify an action in accordance therewith, and perhaps modified by a man-in-the-browser proxy, the server also receives the hash of the form data generated before any man-in-the-browser proxy had access to the form data. The server applies the same cryptographic hash function to the received form data to produce a test hash. In one embodiment, the server use the “jsrsasign” (RSA-Sign JavaScript Library) JavaScript implementation of the known PKCS#1 v2.1 RSASSA-PKCS1-v1_{—}5 RSA signing and validation algorithm to cause the web browser to cryptographically sign the form data and hash and to verify the signature of the web browser.

If the test hash matches the received hash, the server determines that the form data has not been modified by any man-in-the-browser proxy and performs the requested action. Conversely, if the test hash does not match the received hash, the server detects modification of the form data, perhaps by a man-in-the-browser proxy, and accordingly declines to perform the requested action.

In situations in which the requested action is a financial transaction, such as a transfer of funds for example, the man-in-the-browser proxy typically modifies the transaction to transfer funds to an account associated with the source of the man-in-the-browser proxy. As a result, the modified transaction data identifies the perpetrator or an accomplice of the man-in-the-browser proxy. While ordinarily the destination account can be emptied and closed before the unauthorized transfer is ever detected, the server detects the attempted fraud before the unauthorized transfer is ever effected. As a result, all harm is prevented and the account of the perpetrator or accomplice is identified while the account is still active.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a client computer, a server, and a device authentication server that cooperate to verify web-based transactions in accordance with one embodiment of the present invention.

FIGS. 2A and 2B collectively show a transaction diagram illustrating one embodiment according to the invention of a method by which the client computer, server, and device authentication server of FIG. 1 cooperate to verify web-based transactions.

FIG. 3 is a block diagram showing the client computer of FIG. 1 in greater detail.

FIG. 4 is a block diagram showing the server of FIG. 1 in greater detail.

FIG. 5 is a block diagram showing the device authentication server of FIG. 1 in greater detail.

### DETAILED DESCRIPTION

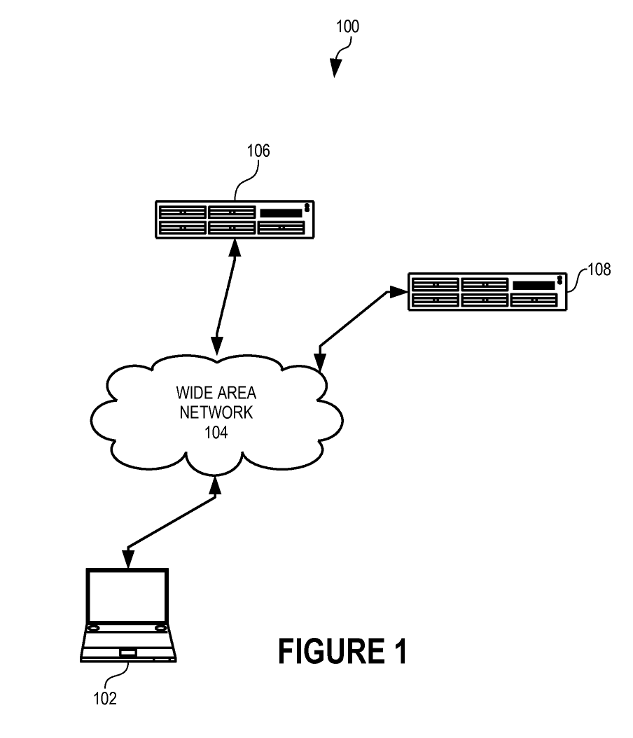

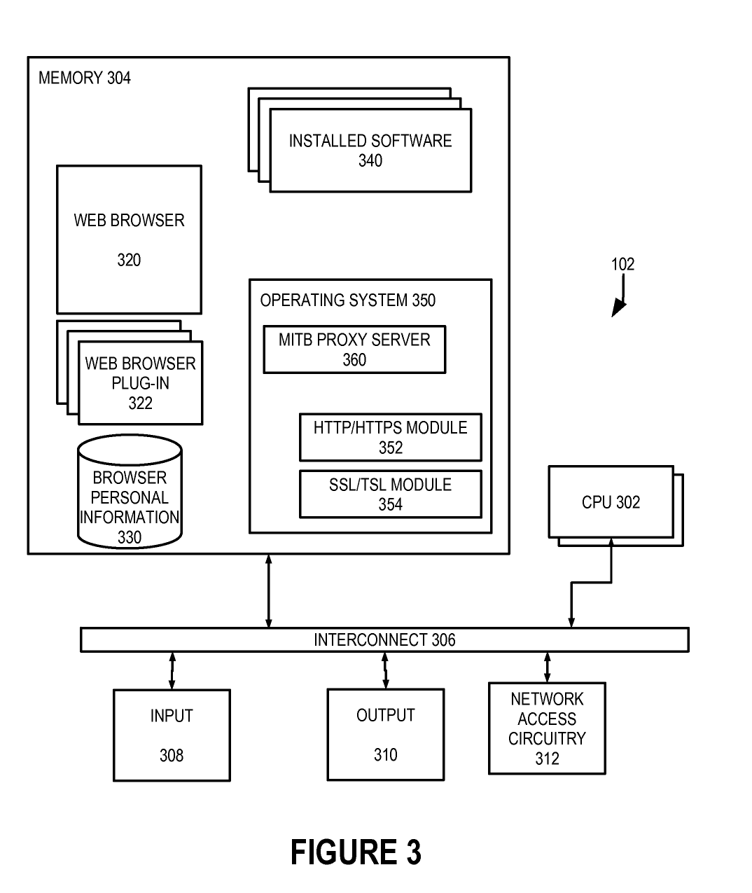

In accordance with the present invention, a client device 102 (FIG. 1) forms a hash of user-specified attributes of a transaction and sends the hash to a server 106 along with the user-specified attributes such that any tampering with the transaction attributes is detected by server 106. The hash is formed by a web browser 320 (FIG. 3) of client device 102 in a manner that cannot be replicated by any man-in-the-browser (MITB) server proxy 360 executing in client computer 102. Accordingly, server 106 (FIG. 1) can determine whether any MITB server proxy has modified the transaction attributes. As a result, server 106 can readily detect a man-in-the-browser attack and prevent even a single fraudulent transaction from being effected.

A transaction verification system 100 (FIG. 1) includes client device 102, server 106, and a device authentication server 108 connected to one another through a wide-area computer network 104, which is the Internet in this illustrative embodiment. In this illustrative example, client device 102 is infected with MITB proxy 360 (FIG. 3) installed therein and of which the user and administrator of client device 102 are unaware. In addition, through web browser 320, the user has authenticated herself with server 106 and is about to request that server 106 transfer funds from one bank account to another.

Though the user is about to request a financial transaction, it should be appreciated that the techniques described herein can apply to other types of actions—financial or other—requested of server 106. Of the numerous types of actions that can be requested of servers such as server 106, one type that is particularly susceptible to harm from MITB attacks is financial transactions and particularly transfer of funds from one account to another in particular.

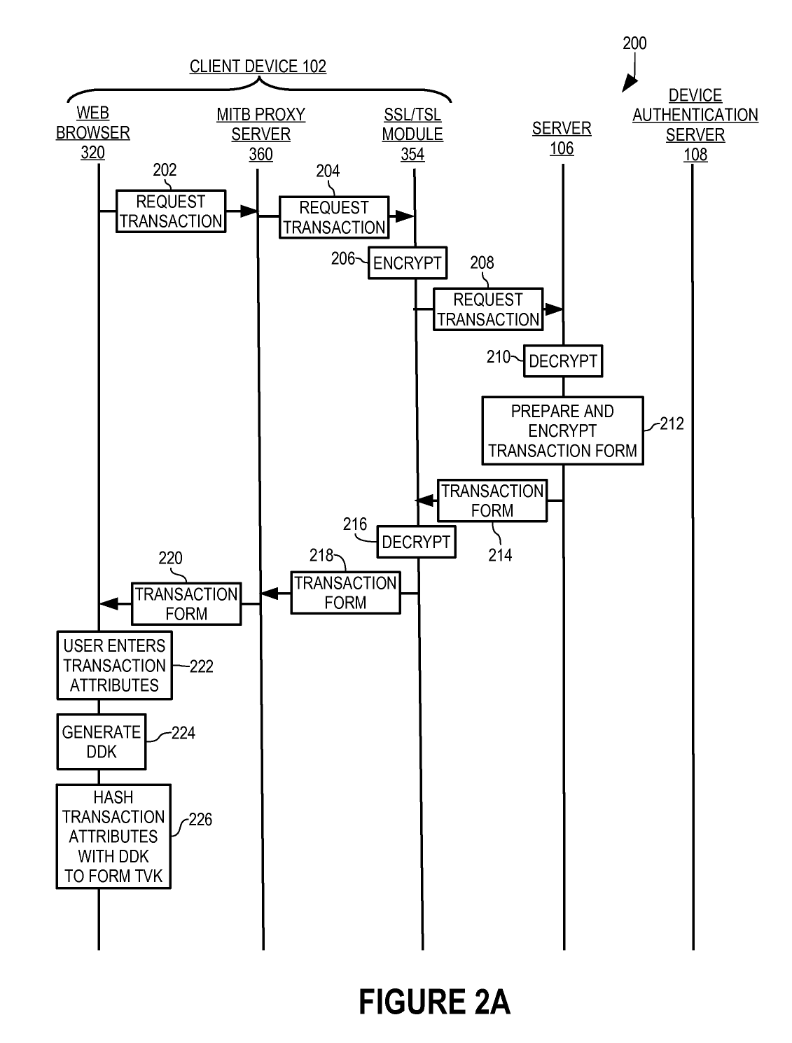

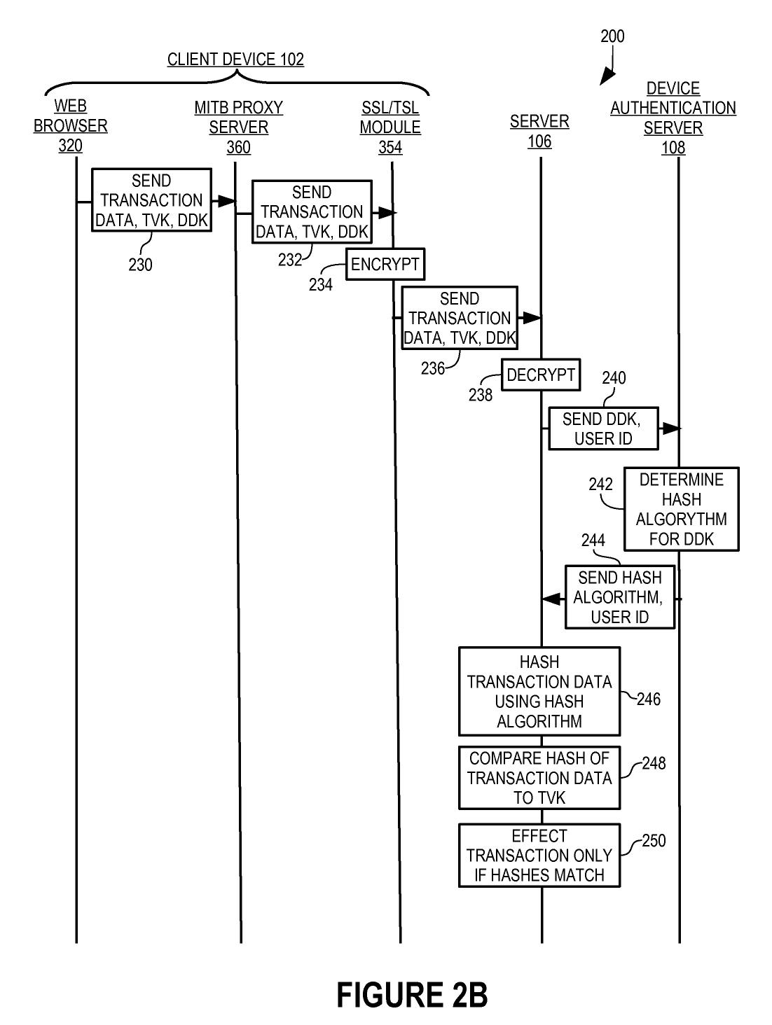

Transaction flow diagram 200 (spanning FIGS. 2A-2B) illustrates the interaction of client device 102, server 106, and device authentication server 108 in verifying the authenticity of transaction attributes specified by the user.

In step 202 (FIG. 2A), web browser 320 of client device 102 sends a transaction request to MITB proxy 360. The transaction request can be a URL associated with a link activated by the user, e.g., by physical manipulation of one or more user input devices 308. Web browser 320 sends the transaction request to MITB proxy 360 because MITB proxy 360 has registered itself as a proxy with operating system 350 in such a manner that all data to and from web browser 320 passes through MITB proxy 360. In other words, web browser 320 sends the transaction request to whatever entity is determined by operating system 350 to be the entity that process such requests. In the context of transaction flow diagram 200 (FIGS. 2A and 2B), if client computer 102 is not infected with MITB proxy 360, all data shown to pass through MITB proxy 360 passes between web browser 320 and SSL/TSL module 354 without intervention or modification.

It should be noted that web browser 320 and MITB proxy 360 communicate with each other in clear text—the data passed therebetween is readable by both. Secure web-based communications is implemented by SSL/TSL module 354 (FIG. 3), e.g., used by HTTP/HTTPS module 352 to implement HTTPS communications. Data received by client computer 106 is decrypted by SSL/TSL module 354 prior to forwarding to web browser 320 and through MITB proxy 360. Similarly, data sent by client computer 106 passes through MITB proxy 360 from web browser 320 prior to being encrypted by SSL/TSL module 354 for transport through wide area network 104. Accordingly, conventional secure web-based communications does not protect against man-in-the-browser attacks.

MITB proxy 360 forwards the transaction request to SSL/TSL module 354 in step 204 (FIG. 2A) for delivery through wide area network 104 (FIG. 1). In this illustrative embodiment, server 106 communicates with client device 102 through a secure HTTPS protocol. Accordingly, SSL/TSL 354 encrypts the transaction request in step 206 (FIG. 2A) and forwards the encrypted transaction request to server 106 through wide area network 104 (e.g., through network access circuitry 312 of FIG. 3).

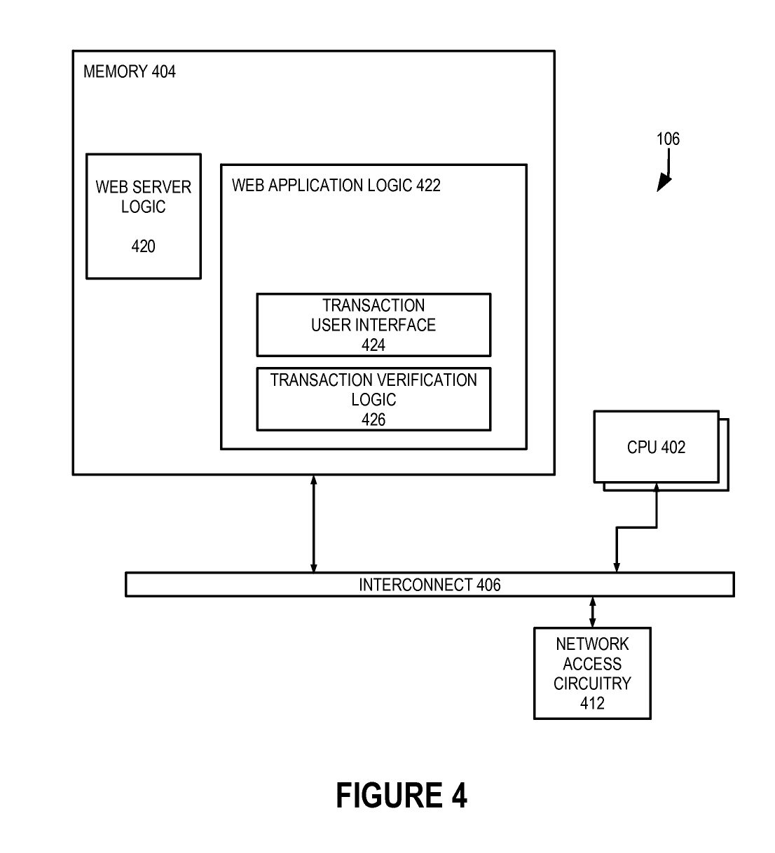

Server 106 includes web server logic 420 (FIG. 4) that includes an analogous SSL/TSL module that decrypts the transaction request in step 210 (FIG. 2A).

Server 106 also includes web application logic 422 (FIG. 4) that specifies the appearance and behavior of a web site, e.g., to provide customer access to banking information and tools including financial transactions. A transaction user interface 424 specifies a web-based user interface by which the user of client device 102 can specify attributes of a requested transaction. In step 212 (FIG. 2A), web application logic 422 (FIG. 4) uses transaction user interface 424 to prepare a web-based form and web server logic 420 encrypts the web-based form. Web server logic 420 sends the web-based form to client device 102 in step 214 (FIG. 2A).

The web-based form is received and decrypted by SSL/TSL module 354 in step 216. Once the web-based form is decrypted, HTTP/HTTPS module 352 forwards the clear text web-based form to MITB proxy 360 in step 218. At this point, MITB proxy 360 can parse the web-based form and recognize the form as representing a financial transfer from one account to another. MITB proxy 360 forwards the web-based form to web browser 320 in step 220.

In step 222, web browser 320 displays the web-based form and receives data that is generated by the user—e.g., by physical manipulation of one or more user input devices 308—and that represents attributes of the transaction that are specified by the user.

In step 224, web browser 320 generates a dynamic device key (DDK) for client computer 102. In particular, a web browser plugin 322 (FIG. 3) is installed in client computer 102 for the purpose of generating dynamic device keys. Alternatively, a DDK generator 342 can be an installed software application of client computer 102 and can be invoked by web browser plugin 322 for generation of the dynamic device key. In step 226, web browser 320, using web browser plugin 322, forms a transaction verification key (TVK) by forming a hash of the transaction attributed specified by the user in step 222, e.g., using the DDK generated in step 224.

There are a number of way in which web browser plugin 322 can generate a device key and a transaction verification key. In one embodiment, web browser plugin 322 generates a dynamic device key in the manner described in U.S. Patent Application Publication US 2011/0009092 and that description is incorporated herein. Briefly, web browser plugin 322 receives a challenge from device authentication server 108 that specifies a number of pieces of system and/or hardware configuration information to be gathered to form a body of data from the gathered information and a key derived from the gathered data by which the body of data is to be cryptographically signed to make the DDK tamper-evident.

In this illustrative embodiment, server 106 requests the challenge from device authentication server 108 and includes the challenge with the transaction form created in step 212 (FIG. 2A). Device authentication server 108 encrypts the challenge for web browser plugin 322 such that the challenge cannot be understood by MITB server proxy 360. In an alternative embodiment, web browser plugin 322 requests and receives the challenge from device authentication server 108 when needed.

Prior to cryptographically signing the body of data, web browser plugin 322 hashes the transaction attributes using the same key to form the transaction verification key and combines the transaction verification key with the body of data prior to cryptographically signing the body of data. Thus, the DDK includes the TVK.

Since the challenge from device authentication server 108 can travel through MITB proxy 360, it is preferred that the challenge be in a form not readily understandable by MITB proxy 360. In one embodiment, the challenge is encrypted using PKI (public key infrastructure) with a public key of web browser plugin 322 such that only web browser plugin 322 can decrypt the challenge.

In alternative embodiments, other techniques can be used by web browser plugin 322 to derive a transaction verification key from the transaction attributes in a manner that is known to device authentication server 108 and obscured from MITB proxy 360 (FIG. 3).

Once web browser plugin 322 has generated the dynamic device key and the transaction verification key, e.g., using DDK generator 342, web browser 320 sends the transaction attributes specified by the user, the dynamic device key, and the transaction verification key to MITB proxy 360 for delivery to server 106 in step 230 (FIG. 2B).

By completion of step 230, MITB proxy 360 may have recognized the transaction as one to be modified and may alter the transaction attributed specified by the user. For example, MITB proxy 360 may replace the recipient's account information with account information of a person intended to receive the funds without consent of the user of client computer 102 and may increase the amount of funds to be transferred up to the available balance of the source account. At this point, none other than MITB proxy 360 realizes that MITB proxy 360 is malicious software and may modify transaction attributes.

In this illustrative embodiment, DDK generator 342 (FIG. 3) is configured (i) to use conventional techniques to identify from which process any request to produce a DDK is received and (ii) to decline requests received from any processes other than a predetermined list of authorized processes. Accordingly, while DDK generator 342 serves requests from web browser 320 and web browser plugin 322, DDK generator 342 declines requests from MITB proxy 360. Thus, should MITB proxy 360 be sufficiently sophisticated and clever to attempt to use DDK generator 342 to generate a DDK and TVK for the modified transaction attributes, DDK generator 342 declines to assist.

In step 232 (FIG. 2B), MITB proxy 360 sends the transaction attributes specified by the user or as modified, the dynamic device key, and the transaction verification key to SSL/TSL module 354 for delivery to server 106. In step 234 (FIG. 2B), SSL/TSL module 354 encrypts the transaction attributes specified by the user or as modified, the dynamic device key, and the transaction verification key and sends the encrypted data to server 106.

An analogous SSL/TSL module of server 106 decrypts the received data in step 238. At this point, server 106 has the transaction attributes as specified by the user and perhaps modified by MITB proxy 360. In step 240, transaction verification logic 426 (FIG. 4) of server 106 sends the dynamic device key and user identifier to device authentication server 108. Server 106 knows the identifier of the user because the user is authenticated as described above.

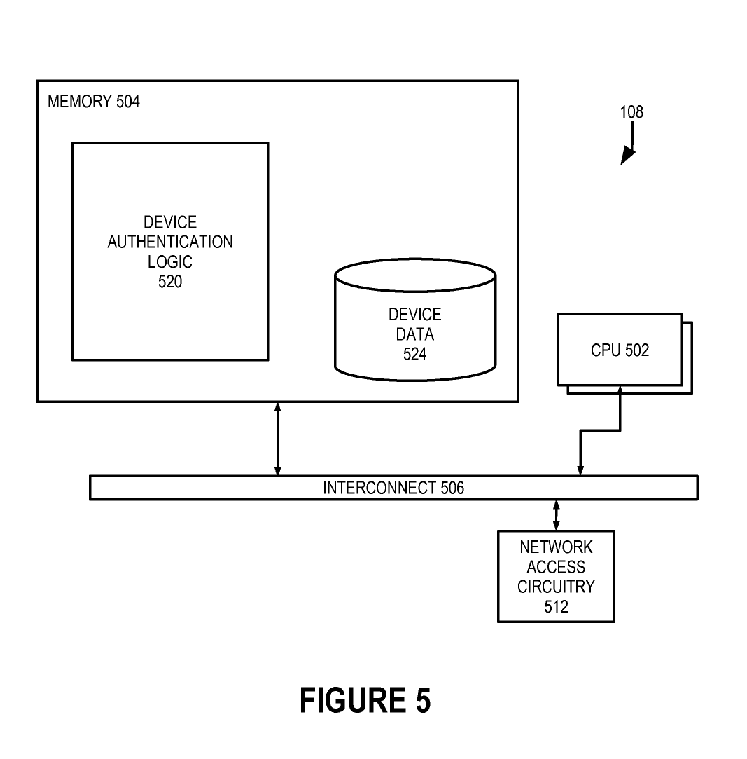

In step 242 (FIG. 2B), device authentication logic 520 (FIG. 5) of device authentication server 108 determines the hash algorithm or key by which the transaction attributes were hashed in step 226 (FIG. 2A). In this illustrative embodiment, device authentication server 108 knows the challenge sent to web browser plugin 322 (the challenge associated with the user identifier as requested from server 106 in step 212—FIG. 2A) and so knows the manner in which the dynamic device key, and its signature key, was derived. In addition, device authentication server 108 includes, in device data 524 (FIG. 5), detailed system and hardware configuration information regarding a number of devices that the user of client computer 102 has registered. Accordingly, device authentication server 108 can apply the same challenge to such system and hardware information of each of the number of devices to determine whether application of the challenge to any of the devices properly verifies the cryptographic signature of the dynamic device key received in step 240 (FIG. 2B).

When device authentication logic 520 determines which of the devices associated with the user identifier verifies the cryptographic signature of the dynamic device key received in step 240, device authentication logic 520 recognizes the signature key as the key with which the transaction attributes are hashed to form the transaction verification key. Device authentication logic 520 sends the signature key, the transaction verification key parsed from the dynamic device key, and user identifier to server 106 in step 244 (FIG. 2B), along with any information required by server 106 to replicate hashing of the transaction attributes, including the hashing algorithm used if not already known by server 106.

In step 244, transaction verification logic 426 hashes the transaction attributed received in step 236 using the hash key and/or algorithm received from device authentication server 108 in step 244.

If the transaction attributes received by server 106 in step 236 are exactly as specified by the user, hashing of those attributes by transaction verification logic 426 using the key and/or algorithm received from device authentication server 108 should result in exactly the same hash as the transaction verification key received from device authentication server 108. Transaction verification logic 426 compares the transaction verification key to the hashed transaction attributes in step 248. A match indicates that the received transaction attributes are exactly as specified by the user of client computer 102. A mismatch indicates that the transaction attributes have been modified after the user specified the attributes.

In step 250, the transaction defined by the transaction attributes specified by the user is effected by server 106, thereby actually transferring funds, only if the transaction verification key matches the transaction attributes as hashed by server 106 in step 246.

It should be appreciated that processing according to transaction flow diagram 200 does not attempt to detect the presence of MITB proxy 360 but instead detects modification of attributes of a transaction after the user has specified the attributes. Accordingly, no anti-virus or anti-spyware tools that are configured to recognize a particular instance of a man-in-the-browser attack are required. In addition, since any and all modifications of transaction attributes—including the first modification thereof—is recognized as such, any man-in-the-browser attack is recognized before any financial harm is caused.

Client computer 102 (FIG. 1) is a personal computing device and is shown in greater detail in FIG. 3. Client computer 102 includes one or more microprocessors 302 (collectively referred to as CPU 302) that retrieve data and/or instructions from memory 304 and execute retrieved instructions in a conventional manner. Memory 304 can include generally any computer-readable medium including, for example, persistent memory such as magnetic and/or optical disks, ROM, and PROM and volatile memory such as RAM.

CPU 302 and memory 304 are connected to one another through a conventional interconnect 306, which is a bus in this illustrative embodiment and which connects CPU 302 and memory 304 to one or more input devices 308, output devices 310, and network access circuitry 312. Input devices 308 can include, for example, a keyboard, a keypad, a touch-sensitive screen, a mouse, a microphone, and one or more cameras. Output devices 310 can include, for example, a display—such as a liquid crystal display (LCD)—and one or more loudspeakers. Network access circuitry 312 sends and receives data through computer networks such as wide area network 104 (FIG. 1).

A number of components of client computer 102 are stored in memory 304. In particular, web browser 320 is all or part of one or more computer processes executing within CPU 302 from memory 304 in this illustrative embodiment but can also be implemented using digital logic circuitry. As used herein, “logic” refers to (i) logic implemented as computer instructions and/or data within one or more computer processes and/or (ii) logic implemented in electronic circuitry. Web browser plug-ins 322 are each all or part of one or more computer processes that cooperate with web browser 320 to augment the behavior of web browser 320. The manner in which a web browser recognizes and interacts with web browser plug-ins to augment the behavior of the web browser is conventional and known and is not described herein.

Installed software 340 and DDK generator 342 are each all or part of one or more computer processes executing within CPU 302 from memory 304. Operating system 350 is all or part of one or more computer processes executing within CPU 302 from memory 304 and can also be implemented using digital logic circuitry. An operating system (OS) is a set of programs that manage computer hardware resources and provide common services for application software such as installed software 340, web browser 320, and web browser plug-ins 322.

HTTP/HTTPS module 352 and SSL/TSL module 354 are modules within operating system 350 and facilitate communications through network access circuitry 312 and wide area network 104 (FIG. 1).

Man-in-the-browser proxy 360 is all or part of one or more computer processes that are installed as a proxy. Whether MITB proxy 360 is really part of operating system 350 is a matter of subjective classification and immaterial. However, MITB proxy 360 is installed in such a manner that operating system 350 directs (i) any data from web browser 320 destined for wide area network 104 and (ii) any data from wide area network 104 destined for web browser 320 through MITB proxy 360.

Server 106 is shown in more detail in FIG. 4. Server 106 includes one or more microprocessors 402 (collectively referred to as CPU 402) that retrieve data and/or instructions from memory 404 and execute retrieved instructions in a conventional manner. Memory 404 can include generally any computer-readable medium including, for example, persistent memory such as magnetic and/or optical disks, ROM, and PROM and volatile memory such as RAM.

CPU 402 and memory 404 are connected to one another through a conventional interconnect 406, which is a bus in this illustrative embodiment and which connects CPU 402 and memory 404 to network access circuitry 412. Network access circuitry 412 sends and receives data through computer networks such as wide area network 104 (FIG. 1).

A number of components of server 106 are stored in memory 404 (FIG. 4). In particular, web server logic 420 and web application logic 422, including transaction user interface 424 and transaction verification logic 426, are all or part of one or more computer processes executing within CPU 402 from memory 404 in this illustrative embodiment but can also be implemented using digital logic circuitry.

Web server logic 420 is a conventional web server. Web application logic 422 is content that defines one or more pages of a web site and is served by web server logic 420 to client devices such as client computer 102 to effect the behavior described above.

Device authentication server 108 is shown in more detail in FIG. 5. Device authentication server 108 includes one or more microprocessors 502 (collectively referred to as CPU 502) that retrieve data and/or instructions from memory 504 and execute retrieved instructions in a conventional manner. Memory 504 can include generally any computer-readable medium including, for example, persistent memory such as magnetic and/or optical disks, ROM, and PROM and volatile memory such as RAM.

CPU 502 and memory 504 are connected to one another through a conventional interconnect 456, which is a bus in this illustrative embodiment and which connects CPU 502 and memory 504 to network access circuitry 512. Network access circuitry 512 sends and receives data through computer networks such as wide area network 104 (FIG. 1).

A number of components of device authentication server 108 are stored in memory 504 (FIG. 5). In particular, device authentication logic logic 520 is all or part of one or more computer processes executing within CPU 502 from memory 504 in this illustrative embodiment but can also be implemented using digital logic circuitry. Device data 524 is data stored persistent in memory 504 and includes data representing system and hardware configuration profiles of computing devices that are known to, and can therefor be authenticated by, device authentication server 108. Device data 524 can be organized as one or more databases.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for detecting unauthorized modification of data specified by a user of a remotely located computer, the method comprising:
receiving action data representing an action to be taken, wherein the action data is received from the remotely located computer;
receiving hash data that is the result of application by the remotely located computer of a cryptographic hash function to original action data that is generated by the remotely located computer in response to physical manipulation of one or more input devices of the remotely located computer, wherein the cryptographic hash function has been sent to the remotely located computer in association with the action to be taken;
applying the cryptographic hash function to the action data to produce test hash data;
determining whether the hash data and the test hash data match one another;
detecting that the action data has been modified without authorization upon a condition in which the hash data and test hash data do not match one another; and
declining to carry out the action in response to detecting that the action data has been modified without authorization.

2. The method of claim 1 wherein the action is a financial transaction.

3. The method of claim 1 wherein applying the cryptographic hash function to the action data to produce test hash data comprises:
requesting the cryptographic hash function from a remotely located server; and
receiving the cryptographic hash function from the remotely located server.

4. The method of claim 3 wherein the request includes the hash data or an identifier or the user data.

5. A non-transitory computer readable medium useful in association with a computer which includes one or more processors and a memory, the computer readable medium including computer instructions which are configured to cause the computer, by execution of the computer instructions in the one or more processors from the memory, to detect unauthorized modification of data specified by a user of a remotely located computer by at least:
receiving action data representing an action to be taken, wherein the action data is received from the remotely located computer;
receiving hash data that is the result of application by the remotely located computer of a cryptographic hash function to original action data that is generated by the remotely located computer in response to physical manipulation of one or more input devices of the remotely located computer, wherein the cryptographic hash function has been sent to the remotely located computer in association with the action to be taken;
applying the cryptographic hash function to the action data to produce test hash data;
determining whether the hash data and the test hash data match one another;
detecting that the action data has been modified without authorization upon a condition in which the hash data and test hash data do not match one another; and
declining to carry out the action in response to detecting that the action data has been modified without authorization.
